(19) United States
(12) Patent Application Publication
(10) Pub. No.: US 2022/0360921 A1
(43) Pub. Date: Nov. 10, 2022

(54) CROS HYBRID BINAURAL HEARING AID SYSTEM

(71) Applicant: Peter Knox, Naples, FL (US)

(72) Inventor: Peter Knox, Naples, FL (US)

(21) Appl. No.: 17/313,864

(22) Filed: May 6, 2021

(51) Int. Cl. H04R 25/00

(52) U.S. Cl. CPC H04R 25/70; H04R 25/606; H04R 2225/55

(57) ABSTRACT

The present application discloses systems and methods for determining one or more configuration settings for a first hearing prosthesis based on configuration data associated with a second hearing prosthesis. In some embodiments, determining the one or more configuration settings for the first hearing prosthesis may include determining an acoustic operating range associated with the first hearing prosthesis based on whether a configured gain at one or more frequencies for the second hearing prosthesis meets or exceeds a target gain at the one or more frequencies. Some embodiments may also include storing the determined configuration settings in a tangible computer readable memory associated with the first hearing prosthesis.

### BACKGROUND

Various types of hearing prostheses may provide persons with different types of hearing loss with the ability to perceive sound. Hearing loss may be conductive, sensorineural, or some combination of both conductive and sensorineural hearing loss.

Conductive hearing loss typically results from a dysfunction in any of the mechanisms that ordinarily conduct sound waves through the outer ear, the eardrum, or the bones of the middle ear. Persons with some forms of conductive hearing loss may benefit from hearing prostheses such as acoustic hearing aids, bone anchored hearing aids, and direct acoustic cochlear stimulation devices.

Sensorineural hearing loss typically results from a dysfunction in the inner ear, including the cochlea where sound vibrations are converted into neural signals, or any other part of the ear or auditory nerve, that may process the neural signals. Persons with some forms of sensorineural hearing loss may benefit from hearing prostheses such as cochlear implants and auditory brain stem implants.

Depending on the severity of the sensorineural hearing loss, some persons may benefit from using a hybrid prosthesis in one ear (e.g., a combined acoustic hearing aid with a cochlear implant). Persons may also benefit from using different prostheses in each ear (e.g., an acoustic hearing aid in one ear and a cochlear implant in the opposite ear). Using separate hearing prostheses may sometimes be referred to as bimodal hearing because the prosthesis recipient is hearing in two modes, e.g., acoustically and electrically in the case where the two prostheses include an acoustic hearing aid and a cochlear implant.

The effectiveness of a hearing prosthesis depends not only on the design of the prosthesis itself but also on how well the prosthesis is configured for or “fitted” to a prosthesis recipient. The fitting of the prosthesis, sometimes also referred to as “programming” or “mapping,” creates a set of configuration settings and other data that define the specific characteristics of the signals (acoustic, mechanical, or electrical) delivered to the relevant portions of the person's outer ear, middle ear, inner ear, or auditory nerve. This configuration information is sometimes referred to as the recipient's “program” or “MAP.”

Current CROS technology essentially shuts down the bad ear, lack of activity and nerve stimulation in the deactivated bad ear side could possibly damage that hearing system even further—that is a medical opinion that medical consensus and common sense tells us that the “use it or lose it” factor is probably in play here—just like most of the rest of the human body.

### SUMMARY

The present application discloses systems, methods, and articles of manufacture for configuring a first hearing prosthesis based on configuration settings associated with a second hearing prosthesis. The first and/or second hearing prostheses may be a cochlear implant, a bone anchored hearing aid, a direct acoustic cochlear stimulation device, an auditory brain stem implant, or an acoustic hearing aid. In some embodiments, the first hearing prosthesis may be a cochlear implant and the second hearing prosthesis may be an acoustic hearing aid.

The device is an enhancement of current contralateral routing of signal (“CROS”) hearing aid technology creating a far superior hearing experience.

Many hearing aid users have tried the CROS and it was unsuccessful for them as having all the noise being processed in JUST the good ear confuses the balance of the brain and although it provides receiving of the noise from the bad side and avoids “head sound blocking effect”, it does not help much with sourcing the direction of noise, which is also a safety and potential health issue.

Medical studies from for example Harvard Medical School clearly state that two hearing aids providing sound to both ears (binaural hearing) has numerous medical and brain processing benefits over just essentially one hearing aid or “monaural”. The conventional CROS is still essentially monoaural as far as the brain and auditory nerve is concerned, even though sound is in theory received from 360 degrees. The CROS simply transmits it from the bad side wirelessly to the one good ear on the good side.

This invention simultaneously retains and maximizes binaural hearing while still providing optimal CROS benefits.

Some embodiments may include determining configuration settings for a first hearing prosthesis based on configuration data associated with a second hearing prosthesis, and storing the determined configuration settings in a tangible computer readable memory associated with the first hearing prosthesis. Some embodiments may additionally include acquiring the configuration data associated with the second hearing prosthesis from a computer readable memory associated with the second hearing prosthesis. Further embodiments may additionally include configuring the first hearing prosthesis based on the determined configuration settings.

In some embodiments, the configuration data associated with the second hearing prosthesis may include data corresponding to whether a gain associated with at least one signal generated by the second hearing prosthesis is within a predefined range of a corresponding target gain.

In some embodiments, determining the configuration settings for the first hearing prosthesis may include determining a first acoustic operating range associated with the first hearing prosthesis. In such embodiments, the first acoustic operating range may include at least one acoustic frequency where a signal generated by the second hearing prosthesis corresponding to the at least one acoustic frequency fails to achieve a target signal level. For embodiments where the first hearing prosthesis includes a sound processor configured to convert acoustic sounds to output signals, determining configuration settings for the first hearing prosthesis may include determining sound processor settings for the first hearing prosthesis. The sound processor settings may include data related to the acoustic operating range.

The first acoustic operating range associated with the first hearing prosthesis may be different than a second acoustic operating rage associated with the second hearing prosthesis in some embodiments. However, in other embodiments, the first acoustic operating range and the second acoustic operating range may be substantially the same. In some embodiments, the first acoustic operating range may at least partially overlap the second acoustic operating range. In still other embodiments, the first acoustic operating range may not overlap the second acoustic operating range.

In some embodiments, the first hearing prosthesis may be configured for use with one of a prosthesis recipient's ears while the second hearing prosthesis may be configured for use with the prosthesis recipient's opposite, or contralateral, ear. However, in other embodiments, the first and second hearing prostheses may be configured for use in the same ear of the prosthesis recipient.

For embodiments where the first hearing prosthesis may be a cochlear implant and the second hearing prosthesis may be an acoustic hearing aid, the configuration settings for the cochlear implant may correspond to frequency allocation table settings for the cochlear implant, and the configuration data for the acoustic hearing aid may correspond to gain settings and/or performance characteristics of the acoustic hearing aid.

The first hearing prosthesis in some embodiments may be a hybrid prosthesis for use with one of a prosthesis recipient's ears. The hybrid prosthesis may comprise a cochlear implant component and an acoustic hearing aid component. In such embodiments, determining configuration settings for the first hearing prosthesis may include determining an acoustic operating range associated with the cochlear implant component. The determined acoustic operating range may include at least one acoustic frequency corresponding to a signal generated by the second hearing prosthesis that fails to meet a target signal level.

### LIST OF FIGURES

FIG. 1 shows a user with the hearing aids of the current invention.

### DETAILED DESCRIPTION

The following detailed description describes various features and functions of the disclosed systems, methods, and articles of manufacture with reference to the accompanying figures. In the figures, similar symbols typically identify similar components, unless context dictates otherwise. The illustrative system, method, and article of manufacture embodiments described herein are not meant to be limiting. Certain aspects of the disclosed embodiments can be arranged and combined in a wide variety of different configurations, all of which are contemplated herein.

Certain aspects of the disclosed systems, methods, and articles of manufacture may be described herein with reference to cochlear implant and acoustic hearing aid embodiments. However, the disclosed systems, methods, and articles of manufacture are not so limited. Many of the disclosed features and functions described with respect to the cochlear implant and acoustic hearing aid embodiments may be equally applicable to other embodiments that may include other types of hearing prostheses, such as, for example, bone anchored hearing aids or types of vibration-based hearing prostheses configured to transmit sound via direct vibration of teeth or other cranial or facial bones, direct acoustic cochlear stimulation devices, auditory brain stem implants, or any other type of hearing prosthesis that may be configured to convert received acoustic signals within a defined acoustic frequency range to one or more output signals, where the output signals are based on the received acoustic signals.

One example configuration is of a first hearing prosthesis and a second hearing prosthesis configured according to some embodiments of the disclosed systems, methods, and articles of manufacture. The first hearing prosthesis and/or the second hearing prosthesis may be a cochlear implant, an acoustic hearing aid, a bone anchored hearing aid or other vibration-based hearing prosthesis, a direct acoustic stimulation device, an auditory brain stem implant, or any other type of hearing prosthesis configured to aid a prosthesis recipient in hearing sound.

The first hearing prosthesis may include a data interface, a microphone, a sound processor, an output signal interface, and data storage, all of which may be connected directly or indirectly via circuitry. Similarly, the second hearing prosthesis may include a data interface, a microphone, a sound processor, an output signal interface, and data storage, all of which may be connected directly or indirectly via circuitry. In some embodiments, the first hearing prosthesis or the second hearing prosthesis may have additional or fewer components. Additionally, the components may be arranged differently. For example, depending on the type and design of the hearing prostheses, the illustrated components may be enclosed within a single operational unit or distributed across multiple operational units (e.g., and external unit, an internal unit, etc.). Similarly, in some embodiments, the first hearing prosthesis may additionally include one or more processors (not shown) configured to determine configuration settings for its sound processor based on configuration data associated with the second hearing prosthesis.

In embodiments where the first hearing prosthesis is a cochlear implant, the microphone may be configured to receive acoustic signals, and the sound processor may be configured to analyze and encode the acoustic signals into electrical stimulation signals for application to an implant recipient's cochlea via an output signal interface that may include an array of electrodes. In embodiments where the second hearing prosthesis is an acoustic hearing aid, the microphone may be configured to receive acoustic signals, and the sound processor may be configured to analyze and encode the acoustic signals into acoustic output signals for applying to a recipient's ear via an output signal interface comprising a speaker.

For embodiments where the first hearing prosthesis or the second hearing prosthesis is a bone anchored hearing aid (BAHA) or other vibration-based hearing prosthesis, the microphone or may be configured to receive acoustic signals, and the sound processor or may be configured to analyze and encode the acoustic signals into mechanical vibration output signals or for applying to the recipient's skull (or teeth or other cranial or facial bone) via output signal interface or that may include a mechanism to transmit sound via direct bone vibrations. Similarly, for embodiments where the first hearing prosthesis or the second hearing prosthesis is a direct acoustic cochlear stimulation (DACS) device, the microphone or may be configured to analyze and encode the acoustic signals into mechanical vibration output signals or for applying to the DACS recipient's inner ear via output signal interface or that may include a mechanism to transmit sound via direct vibration. Finally, for embodiments where the first hearing prosthesis or the second hearing prosthesis is an auditory brain stem implant, the microphone or may be configured to analyze and encode the acoustic signals into electrical stimulation output signals or for applying to the auditory brain stem implant recipient's auditory nerve via output signal interface or that may include one or more electrodes.

A computing device may be configured to execute fitting software for a particular hearing prosthesis and to load configuration settings to the data storage, of a hearing prosthesis, via the prosthesis' data interface. The computing device may include a user interface module, a communications interface module, one or more processors, and data storage, all of which may be linked together via a system bus or other connection circuitry.

The user interface module may be configured to send data to and/or receive data from external user input/output devices such as a keyboard, a keypad, a touch screen, a computer mouse, a track ball, a joystick, and/or other similar devices, now known or later developed. The user interface module may also be configured to provide output to user display devices, such as one or more cathode ray tubes (CRT), liquid crystal displays (LCD), light emitting diodes (LEDs), displays using digital light processing (DLP) technology, printers, light bulbs, and/or other similar devices, now known or later developed. The user interface module may also be configured to generate audible output(s), such as a speaker, speaker jack, audio output port, audio output device, earphones, and/or other similar devices, now known or later developed. In some embodiments, the user interface module may include or be communicatively coupled to an LCD or similar type of touch screen. The touch screen may be configured to display a user interface and/or to receive commands from a user.

The communications interface module may include one or more wireless interfaces and/or wired interfaces that may be configurable to communicate with a hearing prosthesis via a communications connection to a database via communications connection, or to other computing devices. The wireless interfaces may include one or more wireless transceivers, such as a Bluetooth transceiver, a Wi-Fi transceiver, a WiMAX transceiver, and/or other similar type of wireless transceiver configurable to communicate via a wireless protocol. The wired interfaces may include one or more wired transceivers, such as an Ethernet transceiver, a Universal Serial Bus (USB) transceiver, or similar transceiver configurable to communicate via a twisted pair wire, a coaxial cable, a fiber-optic link or a similar physical connection.

The one or more processors may include one or more general purpose processors (e.g., microprocessors manufactured by Intel or Advanced Micro Devices) and/or one or more special purpose processors (e.g., digital signal processors, application specific integrated circuits, etc.).

The one or more processors may be configured to execute computer-readable program instructions that may be contained in the data storage and/or other instructions based on algorithms described herein.

The data storage may include one or more computer-readable storage media that can be read or accessed by at least one of the processors. The one or more computer-readable storage media may include volatile and/or non-volatile storage components, such as optical, magnetic, organic or other memory or disc storage, which can be integrated in whole or in part with at least one of the processors. In some embodiments, the data storage may be implemented using a single physical device (e.g., one optical, magnetic, organic or other memory or disc storage unit), while in other embodiments, the data storage may be implemented using two or more physical devices.

The data storage may include computer-readable program instructions and perhaps additional data. In some embodiments, the data storage may additionally include storage that may be required to perform at least part of the herein-described methods and algorithms and/or at least part of the functionality of the systems described herein.

In some embodiments, the computing device may include software for configuring both the first hearing prosthesis and the second hearing prosthesis. In other embodiments, the first hearing prosthesis and the second hearing prosthesis may be configured by different computing devices.

In some embodiments, the one or more processors of the computing device may be configured to execute fitting software program instructions for determining one or more configuration settings for the first hearing prosthesis based on configuration data associated with a second hearing prosthesis. The computing device may also be configured to store the determined configuration settings in a tangible computer readable memory associated with the first hearing prosthesis. The tangible computer readable memory may include the data storage of the computing device, the data storage of the first hearing prosthesis, and/or database.

In other embodiments, one or more processors (not shown) of the first hearing prosthesis may be configured to execute fitting software program instructions for determining one or more of the configuration settings for the first hearing prosthesis based on configuration data associated with the second hearing prosthesis. The first hearing prosthesis may also be configured to store the determined configuration settings in a tangible computer readable memory, such as the data storage of the first hearing prosthesis, the data storage of the computing device, and/or database.

In some embodiments, the configuration data associated with the second hearing prosthesis may be stored in a tangible computer readable memory associated with the second hearing prosthesis, such as, for example, the data storage of the computing device, the data storage of the second hearing prosthesis, or an external database. In embodiments where the second hearing prosthesis is an acoustic hearing aid, the configuration data associated with the second hearing prosthesis may be in (i) a format proprietary to the second hearing prosthesis manufacturer, (ii) a Hearing Instrument Manufactures' Software Association (HIMSA) Noah database compatible format or other industry standard format, or (iii) some combination of proprietary and industry standard formats.

In some embodiments, as part of determining the one or more configuration settings for the first hearing prosthesis, one or processors (associated with computing device or with the first hearing prosthesis) may be configured to determine an acoustic operating range associated with the first hearing prosthesis based on the configuration data associated with the second hearing prosthesis. The acoustic operating range for the first hearing prosthesis may correspond to a particular range of acoustic frequencies (within the acoustic signal) on which the output signals may be based. For example, the microphone may detect acoustic signals over a wide acoustic frequency range (e.g., 20 Hz-18 kHz), but the sound processor may be configured to generate output signals based on the sounds between 250 Hz and 8 kHz (or some other frequency range or ranges). For example, in embodiments where a prosthesis recipient may wear the first hearing prosthesis in one ear and the second hearing prosthesis in the opposite ear, the acoustic operating range of the first hearing prosthesis may be based at least in part on the configuration settings and/or the performance of the second hearing prosthesis. In such an arrangement, the acoustic operating range of the first hearing prosthesis may be selected to accommodate shortcomings in the performance of the second hearing prosthesis or possibly to enhance the recipient's total hearing experience.

In one embodiments the first hearing prosthesis may be a cochlear implant and the second prosthesis may be an acoustic hearing aid. However, other combinations of hearing prostheses could be used with the disclosed systems, methods, and articles of manufacture.

There could be many different reasons why the actual gain of the acoustic hearing aid might not achieve the target gain at some acoustic frequencies. For example, the acoustic hearing aid may cause undesirable feedback when generating output signals at certain acoustic frequencies. Sometimes, the prosthesis recipient's hearing loss is so profound that the acoustic hearing aid may simply be unable to provide sufficient gain to achieve the target gain at particular acoustic frequencies. In such situations, the acoustic hearing aid recipient may benefit from an additional hearing prosthesis such as a cochlear implant or other hearing prosthesis. The additional hearing prosthesis could be used in the same ear as the acoustic hearing aid or in the recipient's opposite, or contralateral, ear.

Some embodiments of the disclosed systems, methods, and articles of manufacture may include determining the acoustic operating range of the first hearing prosthesis based on configuration data associated with the second hearing prosthesis. For embodiments where the first hearing prosthesis may be a cochlear implant and the second hearing prosthesis may be an acoustic hearing aid, the acoustic operating range of the cochlear implant may be selected to include at least one frequency where the gain generated by the acoustic hearing aid is less than a configurable or predetermined threshold offset from the target gain. In some embodiments, the acoustic operating range of the cochlear implant may be selected to include at least one acoustic frequency where the gain generated by the acoustic hearing aid fails to achieve the target gain.

In one embodiment a person may have a good ear and a bad ear. By both fine tuning sound input to this bad ear with volume settings of a source signal and then separately doing same with the wireless device that wirelessly send sounds to just the good ear from the source signal—hearing balanced surround sound is now possible. The device just provides sound to the good ear side and the microphone is shut down on the CROS microphone on the bad side. This invention provides input to the bad ear and fills in the silence from the bad side in a balanced manner. This is especially good for music and subwoofer frequencies provided an improved hearing experience. Also it provides an “alert” and safety for sounds on the bad side or a person trying to speak to you.

Listening to music with essentially just one ear loses all the “stereo” and “balanced” effect.

This invention retains a great deal of that stereo balanced sound experience.

Most hearing loss is in the speech clarity area and often the bad ear can still hear amplified noise or other noise well—especially music and it can greatly improve the pleasure of listening to music.

And form a safety perspective—hearing a siren or horn and putting natural directional senses of the brain back in play that is otherwise virtually non-existent.

As a result this invention provides in many cases a much improved and healthier and safer hearing experience,

This invention provides not 2 but now 3 sources of sound being sent to the brain in now a balanced manner.

Two sources of sound are currently being amplified by CROS and modified to suit, but are uni-directional and are both sending sound to just the optimum hearing side ear. This invention provides a 3rd sound source to the weak side ear additional from a new Hybrid hearing aid that sends hi volume sound DIRECTLY into the weaker ear, separate and apart from the CROS transmission.

The bad ear does not process speech with good clarity but music frequencies (especially low frequency bass etc.) and some better understanding of speech with two sides processing the sounds in a balanced manner with obvious benefits to the user.

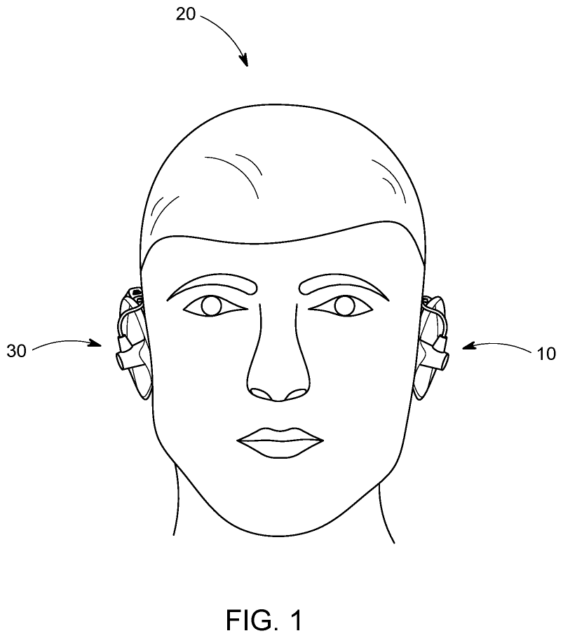

The system is now described by reference to FIG. 1. In FIG. 1 a user, 20, is shown with two hearing aids, 10 and 30. The good ear hearing aid, 10, is a normal hearing aid with an included CROS receiver and processor. The bad ear hearing aid, 30, is a combined normal hearing aid with a CROS system in place.

This Hybrid CROS device, like current CROS systems, provides a single hearing aid located on the bad ear side BUT now has added circuitry to also feed current bad ear custom adjusted sound directly FROM THE BAD SIDE. Current CROS hearing aids now simply send microphone generated sound from the bad ear side to the good ear aid for processing into the good ear only—providing so called “360-degree sound”—but the brain still senses an unbalanced feeling of it being from one side only. This is not good for many reasons as described herein.

The added circuitry would process that same gathered sound from the bad ear side and separately process it to go by conventional wire and speaker to the bad ear bud.

This allows for the hearing aids on both the good ear and the bad ear to be able to be separately adjustable just like a standard hearing aid.

With this invention auditory nerve and complex hearing parts and the brain processing of sound are still active and not essentially shut down from the bad ear. We see this with nerve signals to muscles and say the eyes (lazy eye) and other parts of the body when this happens—causing for example atrophy in muscles.

By using the two-hearing aid CROS system described herein the brain is no longer confused and natural body/brain balance is maintained. The standard, current, CROS systems block input to the bad ear as it is usually held in place by a plastic wire and ear bud in the bad ear. This partially blocks any sound further that otherwise comes in to this bad ear.

Many parts of the human body are in a state of bi-balance by the brain and we have two of many things to keep the brain processing in a balanced manner. Such as sight for depth perception, two ears for balance and directional sense of where sounds are coming from—like a car horn or siren or approaching car or truck.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre AIA) or 35 USC 112(f) post-AIA. Otherwise, no limitations from the specification are to be read into any claims, unless those limitations are expressly included in the claims.

What is claimed is:

1. A method comprising:
determining one or more configuration settings for a first hearing prosthesis based on configuration data associated with a second hearing prosthesis, wherein determining the one or more configuration settings comprises (i) making a determination, based on the configuration data associated with the second hearing prosthesis, of whether a signal generated at an acoustic frequency by the second hearing prosthesis achieves a target signal level, and (ii) determining the one or more configuration settings based on the determination; and
instructing the first hearing prosthesis to store the determined configuration settings in a tangible computer readable memory associated with the first hearing prosthesis,
wherein determining the one or more configuration settings comprises omitting the acoustic frequency from a first acoustic operating range associated with the first hearing prosthesis in response to the determination being that the signal generated at the acoustic frequency by the second hearing prosthesis achieves the target signal level.

2. The method of claim 1, further comprising:
acquiring the configuration data associated with the second hearing prosthesis from a computer readable memory associated with the second hearing prosthesis.

3. The method of claim 1, wherein determining the one or more configuration settings based on the determination comprises:
including the acoustic frequency in the first acoustic operating range associated with the first hearing prosthesis in response to the determination being that the signal generated at the acoustic frequency by the second hearing prosthesis fails to achieve a target signal level; and
determining one or more configuration settings for each acoustic frequency included in the first acoustic operating range.

4. The method of claim 1, wherein the first acoustic operating range associated with the first hearing prosthesis does not overlap a second acoustic operating range associated with the second hearing prosthesis.

5. The method of claim 1, wherein the first hearing prosthesis is configured for use with a first ear of a prosthesis recipient, and wherein the second hearing prosthesis is configured for use with a second ear of the prosthesis recipient.

6. The method of claim 1, wherein the first and second hearing prostheses are configured for use with a first ear of a prosthesis recipient.

7. The method of claim 1, wherein the first hearing prosthesis is one of a cochlear implant, a bone anchored hearing aid, a direct acoustic cochlear stimulation device, an auditory brain stem implant, or an acoustic hearing aid, and wherein the second hearing prosthesis is an acoustic hearing aid.

8. The method of claim 1, wherein the first hearing prosthesis is a cochlear implant and the second hearing prosthesis is an acoustic hearing aid, wherein the one or more configuration settings for the first hearing prosthesis correspond to one or more frequency allocation table settings for the cochlear implant, and wherein the configuration data associated with the second hearing prosthesis corresponds to gain characteristics of the acoustic hearing aid.

9. The method of claim 1, wherein the first hearing prosthesis is a hybrid prosthesis comprising a cochlear implant component and an acoustic hearing aid component, wherein the second hearing prosthesis is an acoustic hearing aid, and wherein determining the one or more configuration settings for the first hearing prosthesis based on configuration data associated with the second hearing prosthesis comprises:
determining an acoustic operating range associated with the cochlear implant component of the first hearing prosthesis, wherein the acoustic operating range includes at least one acoustic frequency corresponding to a signal generated by the second hearing prosthesis that fails to meet a target signal level.

10. An article of manufacture including non-transitory computer-readable media with instructions stored thereon, the instructions comprising:
instructions for determining an acoustic operating range associated with a first hearing prosthesis based on configuration data associated with a second hearing prosthesis, wherein the instructions include, for each of one or more acoustic frequencies:
(i) making a determination of whether a signal generated at the acoustic frequency by the second hearing prosthesis achieves a target signal level, wherein the determination is based on the configuration data associated with the second hearing prosthesis; and
(ii) determining, based on the determination, whether to include the acoustic frequency in the acoustic operating range, wherein, for each of the one or more acoustic frequencies, determining whether to include the acoustic frequency in the acoustic operating range comprises omitting the acoustic frequency from the acoustic operating range in response to the determination being that the signal generated at the acoustic frequency by the second hearing prosthesis achieves the target signal level.

11. The article of manufacture of claim 10, further comprising:
instructions for acquiring the configuration data associated with the second hearing prosthesis from a computer readable memory associated with the second hearing prosthesis; and
instructions for configuring the first hearing prosthesis based on the determined acoustic operating range.

12. The article of manufacture of claim 10, wherein determining, based on the determination, whether to include the acoustic frequency in the acoustic operating range comprises including the acoustic frequency in the acoustic operating range in response to the determination being that the signal generated at the acoustic frequency by the second hearing prosthesis fails to achieve the target signal level.

13. The article of manufacture of claim 10, wherein the first hearing prosthesis is one of a cochlear implant, a bone anchored hearing aid, a direct acoustic cochlear stimulation device, an auditory brain stem implant, or an acoustic hearing aid, and wherein the second hearing prosthesis is a cochlear implant, a bone anchored hearing aid, a direct acoustic cochlear stimulation device, an auditory brain stem implant, or an acoustic hearing aid.

14. The article of manufacture of claim 10, wherein the first hearing prosthesis is a hybrid prosthesis comprising a cochlear implant component and an acoustic hearing aid component, wherein the second hearing prosthesis is an acoustic hearing aid, and wherein the instructions for determining an acoustic operating range associated with the first hearing prosthesis include instructions for determining the acoustic operating range associated with the cochlear implant component of the hybrid prosthesis.

15. A system comprising:
one or more processors configured to determine sound processor settings for a first hearing prosthesis based on configuration data associated with a second hearing prosthesis, wherein the sound processor settings include information indicative of one or more frequency channels included in an acoustic operating range of the first hearing prosthesis, and wherein, to determine the sound processor settings, the one or more processors are further configured to:
(i) make a determination, based on the configuration data associated with the second hearing prosthesis, of whether a gain of a signal generated at a frequency by the second hearing prosthesis meets a target gain, wherein the frequency and the target gain correspond to a frequency channel, and
(ii) determine, based on the determination, whether to include the frequency channel in the acoustic operating range, wherein, in response to the determination being that the signal generated at the frequency by the second hearing prosthesis meets the target gain, the one or more processors are configured to omit the frequency channel from the acoustic operating range; and
computer-readable memory configured to store the determined sound processor settings.

16. The system of claim 15, further comprising:
one or more communications interfaces configured to (i) receive the configuration data associated with the second hearing prosthesis from a computer-readable memory associated with the second hearing prosthesis and (ii) send the determined sound processor settings to the first hearing prosthesis.

17. The system of claim 15, wherein the first hearing prosthesis is one of a cochlear implant, a bone anchored hearing aid, a direct acoustic cochlear stimulation device, an auditory brain stem implant, or an acoustic hearing aid, and wherein the second hearing prosthesis is an acoustic hearing aid.

18. The system of claim 15, wherein the first hearing prosthesis is a hybrid prosthesis comprising a cochlear implant component and an acoustic hearing aid component, and wherein the second hearing prosthesis is an acoustic hearing aid.

19. The system of claim 15, wherein the first hearing prosthesis includes the one or more processors and the computer-readable memory.

20. The system of claim 15, wherein the one or more processors are components of a hearing prosthesis fitting system associated with the first hearing prosthesis.
